(19) United States
(12) Patent Application Publication
(10) Pub. No.: US 2011/0263203 A1
(43) Pub. Date: Oct. 27, 2011

(54) CONNECTOR FOR MEDICAL DEVICE

(75) Inventors: Jayant Parthasarathy, Eden Prairie, MN (US); Douglas R. Maser, Rogers, MN (US)

(73) Assignee: Nonin Medical, Inc., Plymouth, MN (US)

(21) Appl. No.: 13/121,814

(22) PCT Filed: Sep. 29, 2009
(86) PCT No.: PCT/US09/58791

§ 371 Date: Jun. 24, 2011

Related U.S. Application Data
(60) Provisional application No. 61/101,499, filed on Sep. 30, 2008.

(51) Int. Cl. H04W 4/00

(52) U.S. Cl. 455/41.2

(57) ABSTRACT

An apparatus includes a housing, a plurality of electrical contacts, and a transceiver. The housing is configured to engage a feature of a portable device. The plurality of electrical contacts are coupled to the housing and configured to establish an electrical connection with an electrical circuit of the portable device. The transceiver is coupled to the housing and configured to communicate with a secondary device.

### CLAIM OF PRIORITY

This document claims the benefit of priority, under 35 U.S.C. §119(e), to U.S. Provisional Patent Application Ser. No. 61/101,499, entitled “CONNECTOR FOR MEDICAL DEVICE,” filed on Sep. 30, 2008 (Attorney Docket No. 2898.013PRV). U.S. Provisional Patent Application Ser. No. 61/101,499 is incorporated herein by reference.

### BACKGROUND

A finger-worn pulse oximetry device provides a measure of blood ogygenation. Traditional technologies for communicating the data generated by the device are inadequate.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a perspective view of a finger-tip pulse oximetry device with an interface according to one example.

FIG. 2 illustrates a sectional side view of a finger-tip pulse oximetry device engaged with an interface according to one example.

FIG. 3 illustrates a side view of a medical device and an interface according to one example.

FIG. 4 illustrates a perspective view of a medical device and an interface according to one example.

FIG. 5 illustrates a block diagram of a system according to one example.

FIG. 6 illustrates a block diagram of an interface according to one example.

FIG. 7 illustrates a method according to one example.

### DETAILED DESCRIPTION

An example of the present system is directed to a detachable interface accessory for a medical device. The medical device can include a finger-tip oximeter, a cerebral oximeter, or other device. The medical device can be portable or relatively stationary.

The interface is configured to communicate data with a display station or a monitor station, and in this document, both are referred to as a monitor station or as a secondary device.

In one example, a battery case of a portable medical device (such as a finger-tip oximeter) is replaced with an interface. The interface has a housing or case which includes a transceiver module. In various examples, the transceiver module is configured for wireless communication or configured for wired communication with the monitor station. The monitor station is external to the portable device. The interface includes electrical connectors to communicate between the interface and the portable device. In one example, those electrical connectors are within the battery compartment and internal to the portable device.

In one example, the interface includes a power supply. For example, the power supply can include a battery. In one example, the interface includes a data storage device. The data storage device can include a memory or other means to store data.

In one example, the interface includes a user-accessible connector. The user-accessible connector (having, for example, suitable sockets or pins), allows a user to establish a wired connection between the interface and the secondary device. In this example, the portable device can operate at different times both without a cord and with a cord. The wired connection, as with the wireless link of other examples, can allow bi-directional communication between the portable device and the secondary device.

In one example, the portable device includes a communication port that remains accessible regardless of whether or not the interface is installed.

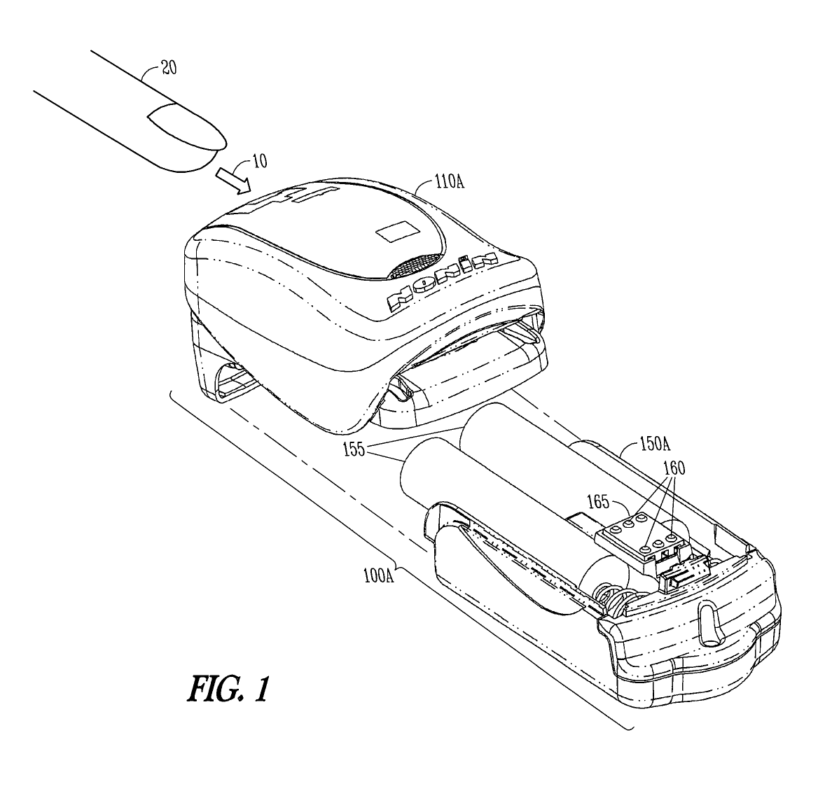

FIG. 1 illustrates system 100A including a perspective view of medical device 110A with an interface 150A according to one example. Medical device 110A is portable and in the figure, is depicted as a finger-tip pulse oximetry device. Finger tip 20 is inserted in an aperture (not shown) of device 110A by movement in a direction denoted by arrow 10. In one example, device 110A includes electrical circuitry to determine blood oxygenation. The electrical circuitry of device 110A is powered by an electrical supply.

Interface 150A includes an apparatus that engages with a feature of device 110A. For example, interface 150A snaps into a guide or engages with a hook of device 110A. Interface 150A is user-installable or user-removable without the aid of tools.

In the example shown, interface 150A includes batteries 155. Batteries 155 serve as the electrical supply for the electrical circuitry of device 110A or electrical circuitry of interface 150A. In addition, interface 150A includes electrical connector 165. Electrical connector 165 includes a plurality of electrical contacts 160 on a surface. Electrical contacts 160 are configured to electrically connect with a corresponding set of contacts (not shown) of device 110A. In various examples, electrical connector 165 conducts electrical power (for example, from batteries 155 to device 110A) and carries data between device 110A and an electrical circuit of interface 150A.

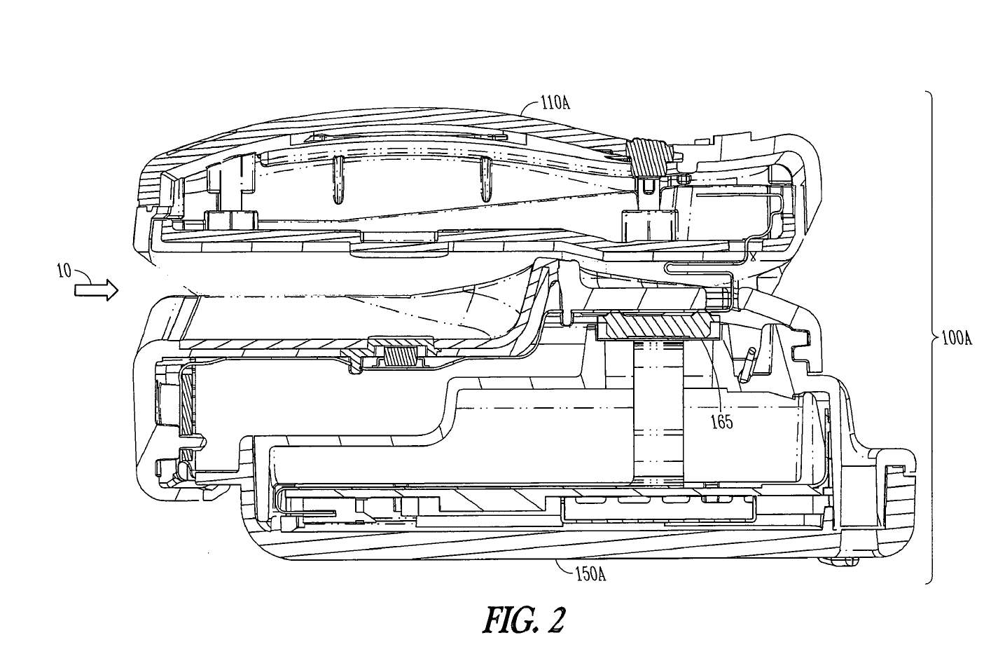

FIG. 2 illustrates system 100A including a sectional side view of device 110A engaged with interface 150A, according to one example. Arrow 10 denotes a direction of insertion of a finger tip in device 110A. Electrical connector 165 is shown in section view. The figure illustrates relative alignment as to device 110A and interface 150A, according to this example.

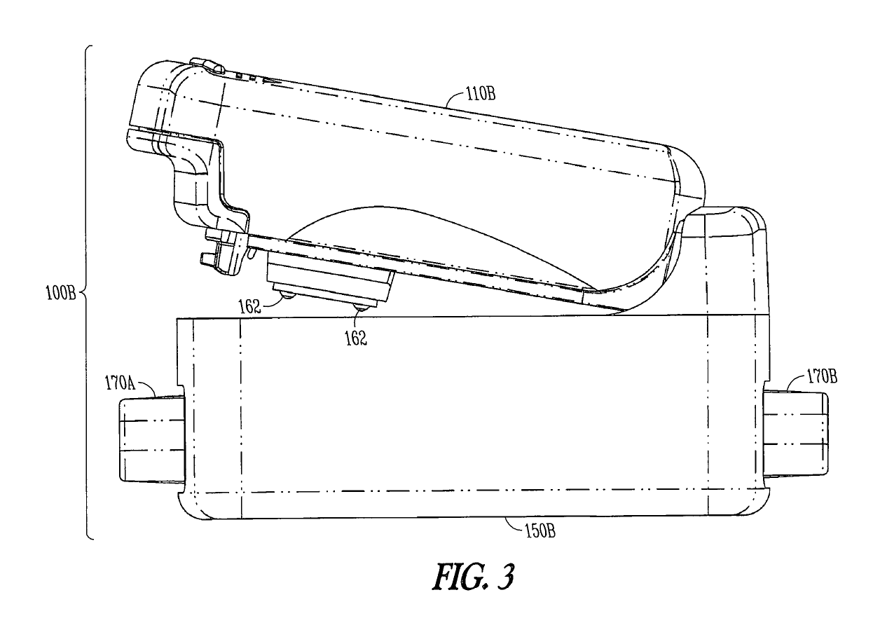

FIG. 3 illustrates a side view of system 100B including medical device 110B and interface 150B according to one example. In this example, device 110B includes a portable medical device. Device 110B includes electrical contacts 162 that engage with electrical contacts (not shown) of interface 150B.

Interface 150B includes connector 170A and connector 170B. In various examples, connectors 170A and 170B are configured to engage with complementary electrical connectors. For example, connector 170A can include a USB connector and connector 170B can include an RS-232 connector. Other connectors, and their corresponding communication protocols, are also contemplated. For example, a connector can include an RJ 45 and an EIA-485 (formerly RS-485 or RS485).

Interface 150B can include a battery (or other power supply), a processor, a memory, or other circuitry.

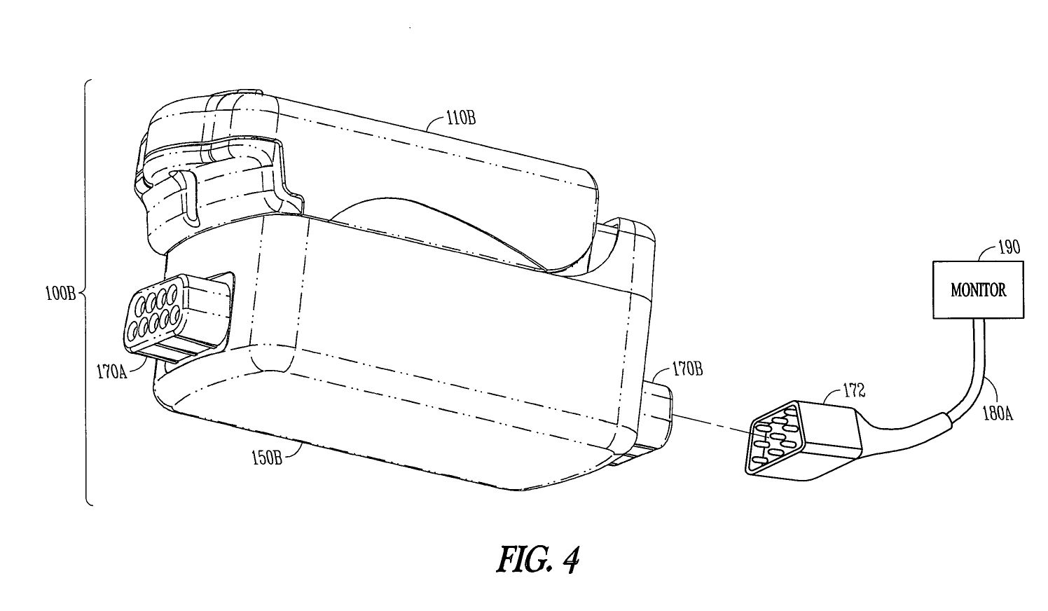

FIG. 4 illustrates a perspective view of system 100B including medical device 110B and interface 150B, according to one example. In the figure, device 110B is physically engaged with, and electrically connected to, interface 150B.

Connector 170A is illustrated to include a 9-pin electrical connector. Connector 170B is shown aligned with complementary connector 172. Complementary connector 172 is coupled to flexible cord 180A. Cord 180A terminates at monitor 190. Cord 180A can include electrical conductors or fiber-optic elements.

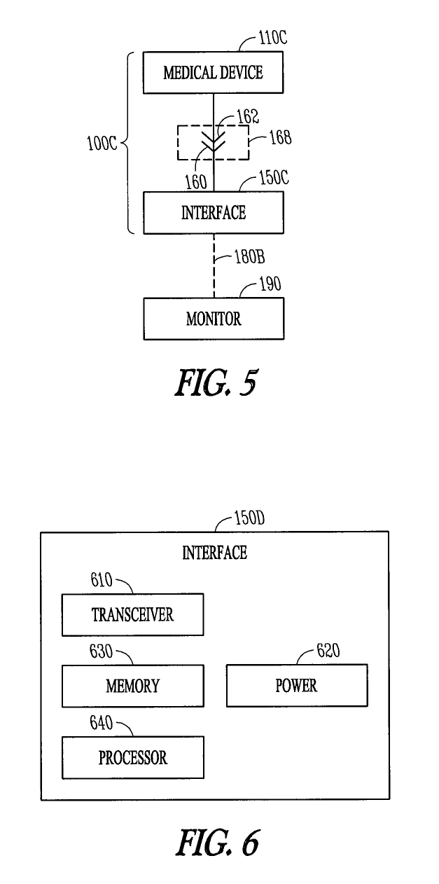

FIG. 5 illustrates a block diagram of system 100C according to one example. System 100C includes medical device 110C and interface 150C, and is shown coupled to monitor station 190. Medical device 110C can include a portable device as described elsewhere in this document. Interface 150C is coupled to device 110C by connector 168 having connector portion 162 coupled to device 110C and connector portion 160 coupled to interface 150C. Connector 168 can include optical elements or electrically conductive elements.

Interface 150C is coupled to monitor station 190 by link 180B. Link 180B can include a wired or wireless connection. For example, in a wired configuration, link 180B can include a USB link, an RS232 link, or other type of connection. In one example, link 180B is wireless and can include any of a variety of wireless communication protocols. For example, link 180B can include an infrared link, a Bluetooth link, a Wi-Fi link, a WIMAX link, a Zigbee link, an IEEE 802 link, a wireless USB link, an ANT link (adaptive isochronous network technology), Z-wave (Zensys and the Z-Wave Alliance) link, or a WMTS (Wireless Medical Telemetry System) link.

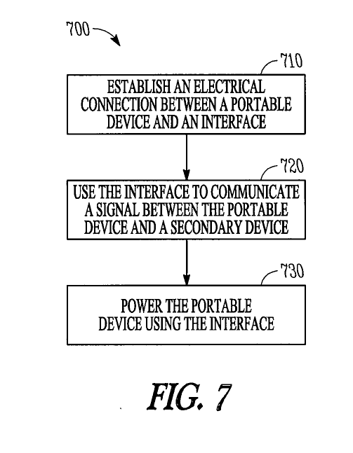

FIG. 6 illustrates a block diagram of interface 150D according to one example. A variety of elements are shown as part of interface 150D, however, in various examples, fewer or more elements than shown are included.

Transceiver 610 of interface 150D supports wired or wireless communication between device 110C and monitor station 190, for example.

Power 620 can include a battery, a fuel cell, a solar cell, or other power supply. In various examples, power 620 supplies electrical power to circuitry of interface 150C and circuitry of device 110C.

Memory 630 provides storage for data. The data can originate with medical device 110C, for example, or originate with monitor station 190. The data can include authentication and access codes to maintain security of communications between device 110C and monitor station 190.

Processor 640 of interface 150D executes instructions (stored, for example, in memory 630) to control operation of interface 150D. For example, processor 640 can manage communications between device 110C and monitor station 190, assure security of communications, perform diagnostic functions, and manage power resources. In one example, memory 630 provides storage for data from device 110C while operating out of range of monitor station 190. At a later time, for example when device 110C is in range of monitor station 190, processor 640 forwards the data stored in memory 630 to monitor station 190.

Other elements are also contemplated for inclusion in interface 150D. For example, interface 150D can include a pre-amplifier or other circuitry.

FIG. 7 illustrates method 700 according to one example. At 710, method 700 includes establishing an electrical connection between a portable device and an interface. The electrical connection can be established concurrent with assembling the medical device to the interface.

At 720, method 700 includes using the interface to communicate a signal between the portable device and a secondary device. The signal can be communicated wirelessly or by a wired connection.

At 730, method 700 includes powering the portable device using the interface. The interface can include a battery or other power supply.

### ADDITIONAL NOTES

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown and described. However, the present inventors also contemplate examples in which only those elements shown and described are provided.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. An apparatus comprising:
a housing configured to engage a feature of a portable device;
a plurality of electrical contacts coupled to the housing and configured to establish an electrical connection with an electrical circuit of the portable device; and
a transceiver coupled to the housing and configured to communicate with a secondary device.

2. The apparatus of claim 1 wherein the housing is configured to engage a battery compartment of the portable device.

3. The apparatus of claim 1 wherein the plurality of electrical contacts are configured to conduct electrical power for the portable device.

4. The apparatus of claim 1 wherein the plurality of electrical contacts are configured to communicate data between the portable device and a secondary device.

5. The apparatus of claim 1 wherein the transceiver is configured to communicate using a wired connection.

6. The apparatus of claim 5 further including an electrical connector affixed to the housing and coupled to the transceiver.

7. The apparatus of claim 6 wherein the electrical connector is compatible with a USB connector.

8. The apparatus of claim 6 wherein the electrical connector is compatible with at least one of an RS232 communication protocol and an RS-485 communication protocol.

9. The apparatus of claim 1 wherein the transceiver is configured to communicate using a wireless link.

10. The apparatus of claim 9 wherein the wireless link includes at least one of an infrared link, a Bluetooth link, a Wi-Fi link, a WIMAX link, a Zigbee link, an IEEE 802 link, a wireless USB link, an ANT link, a Z-wave link, and a WMTS link.

11. The apparatus of claim 1 further including a battery compartment coupled to the housing and configured to receive at least one battery.

12. The apparatus of claim 1 further including a memory coupled to the plurality of electrical contacts, the memory configured to store data for the portable device.

13. A method comprising:
establishing an electrical connection between a portable device and an interface;
using the interface to communicate a signal between the portable device and a secondary device; and
powering the portable device using the interface.

14. The method of claim 13 wherein the signal is communicated in substantially real time.

15. The method of claim 14 wherein the signal is communicated after a time delay.

16. The method of claim 13 wherein using the interface includes connecting an electrical connector to the interface.

17. The method of claim 13 wherein using the interface includes establishing a wireless link between the portable device and the secondary device.

18. The method of claim 13 further including storing data from the portable device in a memory of the interface.
